(19) United States
(12) Patent Application Publication
(10) Pub. No.: US 2025/0001892 A1
(43) Pub. Date: Jan. 2, 2025

(54) CHARGING PLAN CREATING APPARATUS

(71) Applicant: DENSO CORPORATION, Kariya-city (JP)

(72) Inventors: Hiroyuki NANJO, Kariya-city (JP); Noriaki IKEMOTO, Kariya-city (JP)

(73) Assignee: DENSO CORPORATION, Kariya-city (JP)

(21) Appl. No.: 18/751,389

(22) Filed: Jun. 24, 2024

(30) Foreign Application Priority Data
Jun. 28, 2023 (JP) 2023-105922

(51) Int. Cl. B60L 53/62; B60L 58/10; G07C 5/04

(52) U.S. Cl. CPC B60L 53/62; G07C 5/04; B60L 58/10

(57) ABSTRACT

In a charging plan creating apparatus, a charging plan creator obtains a level of energy variation for a first travel route as a first level of energy variation, and obtains a level of energy variation for a second travel route as a second level of energy variation. The charging plan creator allocates, based on a common stop time of both first and second electric vehicles in accordance with a comparison between the first level of energy variation for the first travel route and the second level of energy variation for the second travel route to accordingly create first and second charging plans for the respective first and second electric vehicles.

### CROSS-REFERENCE TO RELATED APPLICATION

This application is based on and claims the benefit of priority from Japanese Patent Application No. 2023-105922 filed on Jun. 28, 2023, the disclosure of which is incorporated in its entirety herein by reference.

### TECHNICAL FIELD

The present disclosure relates to apparatuses for creating a charging plan for a plurality of electric vehicles.

### BACKGROUND

Japanese Patent Application Publication No. 2022-118575 discloses a charging system for creating a charging plan that schedules charging of a plurality of electric vehicles.

### SUMMARY

Energy consumed by traveling of each of electric vehicles may vary depending on situations related to traveling of the corresponding one of the electric vehicles. This is a completely natural for different electric vehicles. Even for an electric vehicle, energy consumed by traveling of the electric vehicle on a first travel route may be different from that consumed by traveling of the electric vehicle on a second travel route if the situations of the first travel route are different from those of the second travel route. Energy consumed by traveling of an electric vehicle may also vary depending on driving operations of the electric vehicle in addition to the variations in traveling routes.

The charging system disclosed in the patent publication may unfortunately create a charging plan for a plurality of electric vehicles without consideration of such variations in traveling energy consumed by the plurality of electric vehicles. This may therefore result in the disclosed charging system creating, for a plurality of electric vehicle, traveling plans having poor energy efficiency.

From this viewpoint, the present disclosure seeks to provide methods and apparatuses, each of which is capable of creating a charging plan for each of a plurality of electric vehicles; the created charging plan for each electric vehicle adapts to a variation in values of traveling energy consumed by the corresponding electric vehicle.

A first exemplary aspect of the present disclosure provides a charging plan creating apparatus. The charging plan creating apparatus includes a variation calculator configured to calculate, based on information on traveling energy required for a traveling of at least one electric vehicle along each of a plurality of travel routes, a level of energy variation in one of (i) values of the traveling energy required for the traveling of the at least one electric vehicle along each of the plurality of travel routes, and (ii) values of at least one influence factor for each of the plurality of travel routes. The at least one influence factor influences the traveling energy. The charging plan creating apparatus includes a charging plan creator.

The charging plan creator is configured to obtain the level of energy variation for a first travel route included in the plurality of travel routes as a first level of energy variation, and obtain the level of energy variation for a second travel route included in the plurality of travel routes as a second level of energy variation.

The charging plan creator is configured to allocate, based on a common stop time of both the first and second electric vehicles included in first and second traveling plans for the respective first and second electric vehicles, a usable charging time to the first and second electric vehicles in accordance with a comparison between the first level of energy variation for the first travel route and the second level of energy variation for the second travel route to accordingly create first and second charging plans for the respective first and second electric vehicles.

A second exemplary aspect of the present disclosure provides a charging apparatus. The charging apparatus includes a charging plan creating apparatus according to the first exemplary aspect, and a charging executing unit configured to execute charging of a battery of the first electric vehicle in accordance with the first charging plan for the first electric vehicle, and execute charging of a battery of the second electric vehicle in accordance with the second charging plan for the second electric vehicle.

A third exemplary aspect of the present disclosure provides a charging program product for at least one processor. The program product includes a non-transitory computer-readable storage medium, and a set of computer program instructions stored in the computer-readable storage medium. The instructions cause the at least one processor to calculate, based on information on traveling energy required for a traveling of at least one electric vehicle along each of a plurality of travel routes, a level of energy variation in one of (i) values of the traveling energy required for the traveling of the at least one electric vehicle along each of the plurality of travel routes, and (ii) values of at least one influence factor for each of the plurality of travel routes, the at least one influence factor influencing the traveling energy.

The instructions cause the at least one processor to obtain the level of energy variation for a first travel route included in the plurality of travel routes as a first level of energy variation, and obtain the level of energy variation for a second travel route included in the plurality of travel routes as a second level of energy variation.

The instructions cause the at least one processor to allocate, based on a common stop time of both the first and second electric vehicles included in first and second traveling plans for the respective first and second electric vehicles, a usable charging time to the first and second electric vehicles in accordance with a comparison between the first level of energy variation for the first travel route and the second level of energy variation for the second travel route to accordingly create first and second charging plans for the respective first and second electric vehicles.

The first to third exemplary aspects respectively offer the charging plan creating apparatus, the charging apparatus, and the charging program product, each of which is configured to allocate the usable charging time to the first and second electric vehicles in accordance with determination of whether the first level of energy variation for the first travel route is greater than the second level of energy variation for the second travel route to accordingly create first and second charging plans for the respective first and second electric vehicles.

Because the first and second levels of energy variation for the respective first and second travel routes depend on traveling energy consumed by the respective first and second electric vehicles that travel along the first and second travel routes, this configuration of each of the charging plan creating apparatus, the charging apparatus, and the charging program product makes it possible to suitably allocate, based on the difference between the traveling-energy consumptions of the first and second electric vehicles, the usable charging time to the first and second electric vehicles.

### BRIEF DESCRIPTION OF THE DRAWINGS

Other aspects of the present disclosure will become apparent from the following description of embodiments with reference to the accompanying drawings in which:

FIG. 1 is a hardware and block diagram schematically illustrating an exemplary hardware configuration and functional components of a charging apparatus according to the first embodiment;

FIG. 2 is a flowchart schematically illustrating a charging plan creating routine carried out by the charging apparatus;

FIG. 3A is a timing chart schematically illustrating an example of traveling energy information on at least one electric vehicle stored in a traveling information storage;

FIG. 3B is a timing chart schematically illustrating an example of a traveling plan for a first electric vehicle;

FIG. 3C is a timing chart schematically illustrating an example of a traveling plan for a second electric vehicle;

FIG. 4 is a timing chart schematically illustrating an example of a charging plan;

FIG. 5A is a timing chart schematically illustrating an example of a charging plan for a first electric vehicle;

FIG. 5B is a timing chart schematically illustrating an example of a charging plan for a second electric vehicle; and

FIG. 6 is a flowchart schematically illustrating a charging plan creating routine carried out by a charging apparatus according to the third embodiment.

### DETAILED DESCRIPTION OF EMBODIMENTS

The following describes exemplary embodiments of the present disclosure with reference to the accompanying drawings. In the embodiment and its modifications, descriptions of like parts between the exemplary embodiments and their modifications, to which like reference characters are assigned as much as possible, are omitted or simplified to avoid redundant description.

### First Embodiment

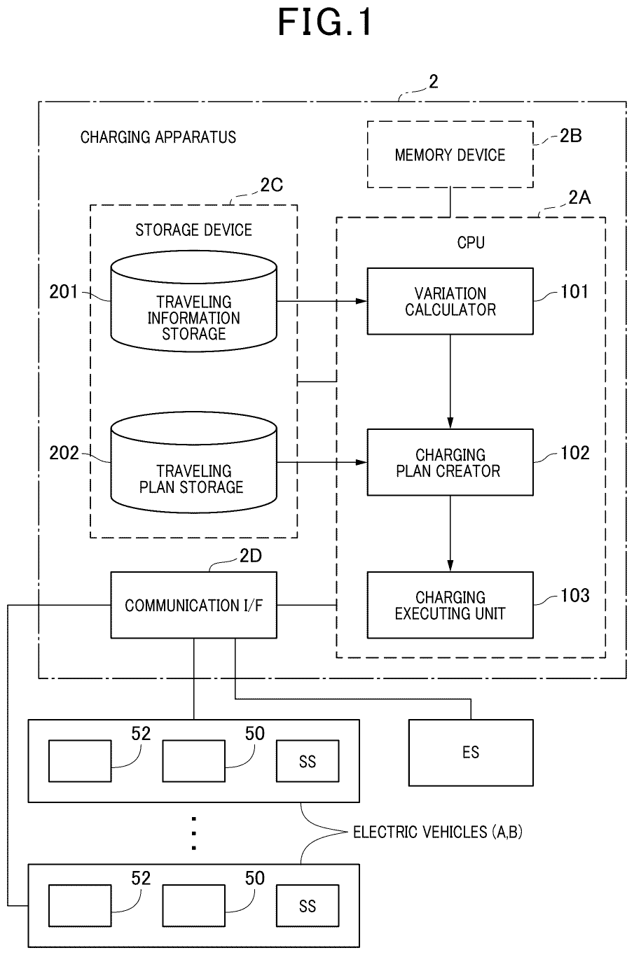

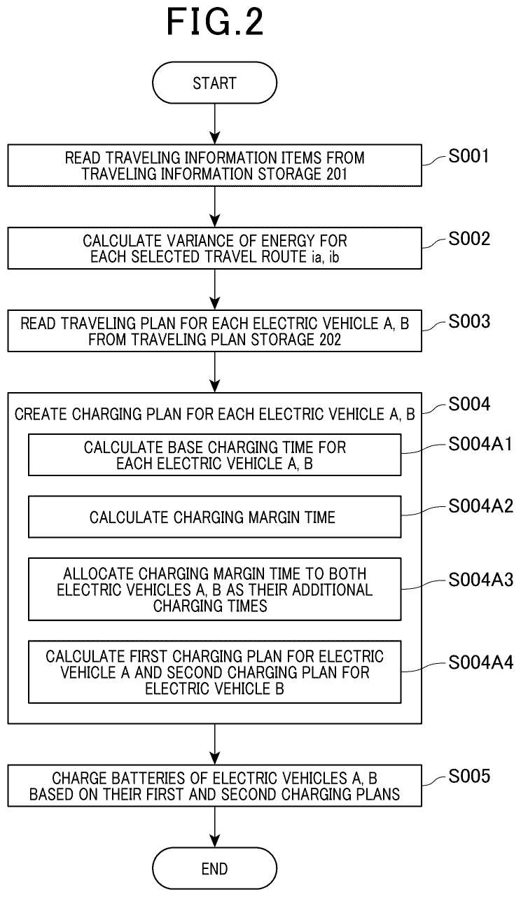

FIG. 1 is a hardware and block diagram schematically illustrating an exemplary hardware configuration and functional components of a charging apparatus 2 according to the first embodiment. FIG. 2 is a flowchart schematically illustrating a charging plan creating routine carried out by the charging apparatus 2.

The charging apparatus 2 is configured to create a charging plan for a plurality of usable electric vehicles, and charge a battery 52 of each of the usable electric vehicles in accordance with the created charging plan for the corresponding one of the usable electric vehicles.

That is, the charging apparatus 2 can also serve as a charging plan creating apparatus for creating a charging plan for each of the usable electric vehicles.

Specifically, the charging apparatus 2 is configured as a computer system that includes, for example, a processor, such as a central processing unit (CPU), 2A, a memory device 2B, a storage device 2C, and a communication interface (I/F) 2D. These components 2A, 2B, 2C, and 2D are communicably connected to one another. A storage device can serve both the memory device 2B and the storage device 2C.

Additionally, the charging apparatus 2 for example functionally includes, as illustrated in FIG. 1, a variation calculator 101, a charging plan creator 102, and a charging executing unit 103. The storage device 2C includes a traveling information storage 201 and a traveling plan storage 202. The storage device 2C can be installed in the charging apparatus 2 or separated from the charging apparatus 2.

The CPU 2A is configured to execute one or more computer programs, i.e., computer program instructions, installed in the memory device 2B to accordingly implement various functions corresponding the one or more computer programs; the various functions include the above functions 101 to 103.

At least part of all functions, which include the functions 11 to 13, provided by the charging apparatus 2 can be implemented by at least one processor, such as the CPU 2A; the at least one processor can be comprised of
(1) The combination of at least one programmable processing unit, i.e., at least one programmable logic circuit, and at least one memory
(2) At least one hardwired logic circuit
(3) At least one hardwired-logic and programmable-logic hybrid circuit

The traveling information storage 201 stores, for example, for each of usable travel routes i, traveling energy information on at least one electric vehicle in the usable electric vehicles; the usable travel routes include travel routes ia, and ib.

The traveling energy information on the at least one electric vehicle for each travel route i includes values of traveling energy that were required for plural traveling actions of the at least one electric vehicle along the corresponding travel route i.

The values of the traveling energy of the at least one electric vehicle for each travel route i can be measured values that were actually used for plural traveling actions of the at least one electric vehicle along the corresponding travel route i, or can be predicted values that were predicted for plural traveling actions of the at least one electric vehicle along the corresponding travel route i.

The traveling energy information on the at least one electric vehicle may include a plurality of energy influence factors that have an influence on each of the values of the traveling energy of the at least one electric vehicle.

The plurality of energy influence factors influencing each value of the traveling energy of the at least one electric vehicle measured during traveling of the at least one electric vehicle along each travel route i may include
(I) A first energy influence factor indicative of a distance, which will be referred to as a travel distance, traveled by the at least one electric vehicle along the corresponding travel route i
(II) A second energy influence factor indicative of a time, which will be referred to as a travel time, required for the traveling of the at least one electric vehicle along the corresponding travel route i
(III) A third energy influence factor, i.e., a traffic situation factor, indicative of a traffic situation of the corresponding travel route i during the traveling of the at least one electric vehicle along the corresponding travel route i
(IV) A fourth energy influence factor indicative of the number of stops of the at least one electric vehicle along the corresponding travel route i
(V) A fifth energy influence factor indicative of an average speed of the at least one electric vehicle during the traveling of the at least one electric vehicle along the corresponding travel route i
(VI) A sixth energy influence factor indicative of the number of driver changes of the at least one electric vehicle during the traveling of the at least one electric vehicle along the corresponding travel route i
(VII) A seventh energy influence factor, i.e., a driving-operation variation factor, indicative of variations of driving operations of the at least one electric vehicle during the traveling of the at least one electric vehicle along the corresponding travel route i
(VIII) An eighth energy influence factor, i.e., a weather condition factor, indicative of a weather condition during the traveling of the at least one electric vehicle along the corresponding travel route i

The third energy influence factor for the at least one electric vehicle may for example include
(i) A traffic volume, i.e., a count of vehicles that traveled past the predetermined travel route during the traveling of the at least one electric vehicle along the corresponding travel route i
(ii) Average speeds of the counted vehicles

The seventh energy situation factor for the at least one electric vehicle may include, for example, the number of accelerations and the number of decelerations during the traveling of the at least one electric vehicle along the corresponding travel route i.

The eighth energy situation factor for the at least one electric vehicle may include (i) an ambient temperature change, (ii) a direction change of wind, and (iii) a wind-power change during the traveling of the at least one electric vehicle along the corresponding travel route i.

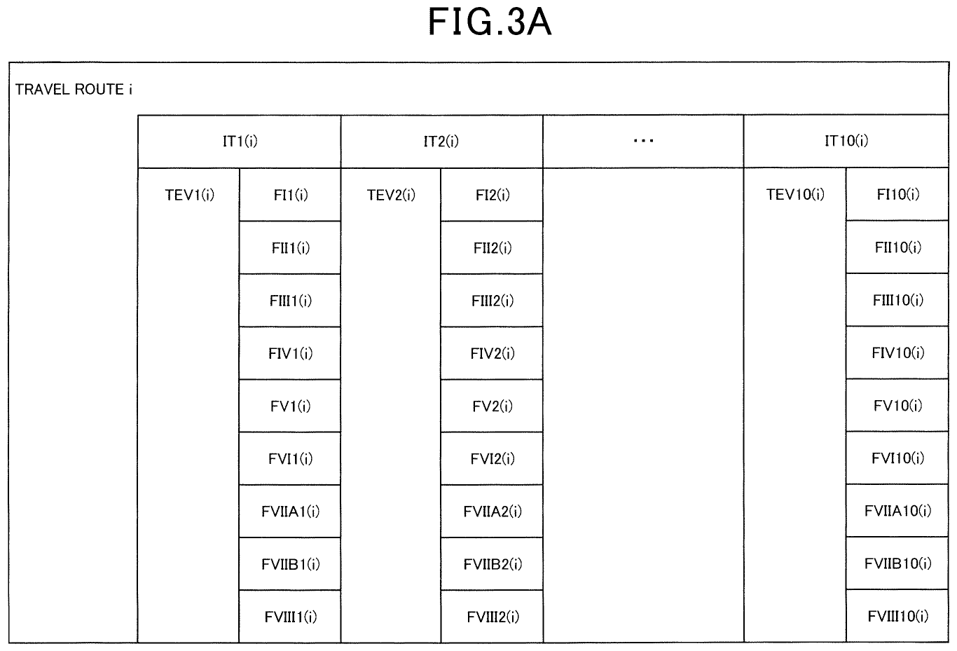

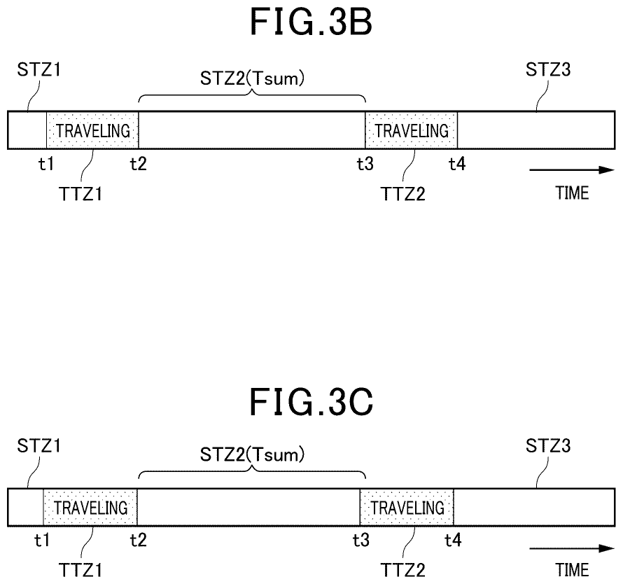

FIG. 3A illustrates an example of the traveling energy information on the at least one electric vehicle stored in the traveling information storage 201.

Specifically, past ten traveling actions, i.e., first to tenth traveling actions, of the at least one electric vehicle along each travel route i were carried out so that ten values of the traveling energy, i.e., first to tenth values of the traveling energy TEV1(i) to TEV10(i), were measured for the respective first to tenth traveling actions.

At that time, a first traveling information item IT1(i) related to the first traveling energy value TEV1(i) to a tenth traveling information item IT10(i) related to the tenth traveling energy value TEV10(i) included in the traveling energy information are stored in the traveling information storage 201.

For example, the first traveling information item IT1(i) includes (i) the first traveling energy value TEV1(i), (ii) a value FI1(i) of the travel distance as the first influence factor, (iii) a value FII1(i) of the travel time as the second influence factor, (iv) a value FIII1(i) of the traffic volume as the third influence factor, (v) a value FIV1(i) of the number of stops of the at least one electric vehicle as the fourth influence factor, (vi) a value FV1(i) of the average speed of the at least one electric vehicle as the fifth influence factor, (vii) a value FVI1(i) of the number of driver changes of the at least one electric vehicle as the sixth influence factor, (viii) a value FVIIA1(i) of the number of accelerations of the at least one electric vehicle as the seventh influence factor, (ix) a value FVIIB1(i) of the number of decelerations of the at least one electric vehicle as the seventh influence factor, and (x) a value FVIII1(i) indicative of the direction change of wind as the eighth influence factor. Each of the remaining second to tenth traveling information items IT2(i) to IT10(i) has a substantially identical data configuration to that of the first traveling information item IT1(i).

The traveling plan storage 202 stores, for example, a traveling plan for each electric vehicle; the traveling plan for each electric vehicle represents how the corresponding electric vehicle is scheduled to travel along each travel route i.

Specifically, the traveling plan for each electric vehicle includes, for example, at least one actual traveling time zone and at least one stop time zone.

FIG. 3B illustrates an example of the traveling plan for an electric vehicle, i.e., a first electric vehicle, A included in the electric vehicles. Specifically, the electric vehicle A is scheduled to travel along the predetermined travel route ia from time t1 to time t2, and time t3 to time t4. That is, the traveling plan for the electric vehicle A illustrated in FIG. 3B includes a first actual traveling time zone TTZ1 defined from the time t1 to the time t2, and a second actual traveling time zone TTZ2 defined from the time t3 to the time t4. Additionally, the traveling plan illustrated in FIG. 3B includes a first stop time zone STZ1 defined before the time t1, a second stop time zone STZ2 defined between the time t2 and the time t3, and a third stop time zone STZ3 defined after the time t4. Each of the first to third stop time zones STZ1 to STZ3 represents a chargeable time during which the target electric vehicle A is chargeable.

FIG. 3C also illustrates an example of the traveling plan for an electric vehicle, i.e., a second electric vehicle, B included in the electric vehicles. For example, as illustrated in FIG. 3C, the traveling plan for the electric vehicle B illustrated in FIG. 3C is the same as the traveling plan for the electric vehicle A illustrated in FIG. 3B, so that the traveling plan for the electric vehicle B includes the first and second actual traveling time zones TTZ1 and TTZ2 and the first to third stop time zones STZ1 to STZ3.

For explanatory convenience, FIGS. 3B and 3C illustrate that the traveling plans for the respective electric vehicles A and B are determined such that the electric vehicles A and B are scheduled to travel during the same actual traveling time zones TTZ1 and TTZ2, and stop during the same stop time zones STZ1 to STZ3.

In particular, the second stop time zone STZ2 defined between the first and second actual traveling time zones TTZ1 and TTZ2 is a common stop time zone of both the electric vehicles A and B, so that the second stop time zone STZ2 is a chargeable time zone that is an only chargeable period between the actual traveling schedules. In other words, the second stop time zone STZ2 needs to be shared by charging of the electric vehicle A and charging of the electric vehicle B. The second stop time zone STZ2 will therefore also be referred to as a limited total chargeable time Tsum between the actual traveling schedules.

Each electric vehicle includes, for example, a vehicle drive system 50 including at least one motor, a battery 52, and sensors SS. Specifically, the vehicle drive system 50 of each electric vehicle creates drive power based on direct-current (DC) power supplied from the battery 52 to accordingly transmit the drive power, i.e., torque, to the motor, making it possible to rotate the at least one motor. The rotation of the at least one motor rotates driving wheels of each electric vehicle, thus causing the corresponding electric vehicle to travel.

The sensors SS and the battery 52 of each electric vehicle are communicable with the charging apparatus 2 through the communication I/F 2D.

The sensors SS of each electric vehicle is configured to measure traveling-related information related to traveling of the corresponding electric vehicle and the vehicle drive system 50 of the corresponding electric vehicle is configured to transmit the measured traveling-related information to the vehicle drive system 50 and the charging apparatus 2.

That is, the sensors SS of the selected electric vehicle are configured to measure, for each traveling actions of the selected electric vehicle, at least the first, second, fourth, fifth, sixth, and seventh influence factors in addition to the corresponding traveling energy value, and the vehicle drive system 50 is configured to send, for each traveling actions of the selected electric vehicle, the measured at least the first, second, fourth, fifth, sixth, and seventh influence factors in addition to the corresponding traveling energy value to the charging apparatus 2.

Additionally, the sensors SS of each electric vehicle are configured to cyclically measure a state of charge (SOC) of the battery 52, and the vehicle drive system 50 is configured to send, to the charging apparatus 2, the cyclically measured SOCs of the battery 52 of the corresponding electric vehicle.

Various external sensors and/or servers ES, which are communicable with the communication apparatus 2 through the communication I/F 2D, are configured to acquire, for each of the traveling actions of the at least one electric vehicle, the third and eighth influence factors, and send, for each traveling actions of the at least one electric vehicle, the acquired third and eighth influence factors to the charging apparatus 2.

Accordingly, as described above, the first traveling information item IT1(i) related to the first traveling energy value TEV1(i) to the tenth traveling information item IT10(i) related to the tenth traveling energy value TEV10(i) included in the traveling energy information have been stored in the traveling information storage 201.

The variation calculator 101 is configured to calculate, based on the first to tenth traveling information items IT1(i) to IT10(i), a level of variation in values of an energy-related parameter; the energy-related parameter is one of the traveling energy and at least one of the first to eighth influence factors.

Specifically, the variation calculator 101 is configured to calculate one of
(I) A level of variation in the first to tenth values of the traveling energy TEV1(i) to TEV10(i) for the traveling of the at least one electric vehicle along a selected travel route i
(II) A level of variation in the first to tenth values of at least one of the first to eighth influence factors for the traveling of the at least one electric vehicle along the selected travel route i

The charging plan creator 102 is configured to create a first charging plan for the electric vehicle A and a second charging plan for the electric vehicle B during the limited total chargeable time Tsum in accordance with (i) the traveling plan for the electric vehicle A stored in the traveling plan storage 202, (ii) the traveling plan for the electric vehicle B stored in the traveling plan storage 202, (iii) the first level of variation in the values of the energy-related parameter, i.e., the traveling energy or the at least one of the first to eighth influence factors, for a selected travel route ia in the usable travel routes i of the electric vehicle A, and (iv) the second level of variation in the values of the energy-related parameter, i.e., the traveling energy or the at least one of the first to eighth influence factors, for a selected travel route ib in the usable travel routes i of the electric vehicle B.

Specifically, the charging plan creator 102 is configured to determine whether the first level of variation in the values of the energy-related parameter for the selected travel route ia of the electric vehicle A is greater than the second level of variation in the values of the energy-related parameter for the selected travel route ib of the electric vehicle B.

Then, the charging plan creator 102 is configured to create the first charging plan for the electric vehicle A and the second charging plan for the electric vehicle B such that
(I) The charging time allocated to the electric vehicle A is greater than the charging time allocated to the electric vehicle B upon determination that the first level of variation in the values of the energy-related parameter for the selected travel route ia of the electric vehicle A is greater than the second level of variation in the values of the energy-related parameter for the selected travel route ib of the electric vehicle B
(II) The charging time allocated to the electric vehicle B is greater than the charging time allocated to the electric vehicle A upon determination that the second level of variation in the values of the energy-related parameter for the selected travel route ib of the electric vehicle B is greater than the first level of variation in the values of the energy-related parameter for the selected travel route ia of the electric vehicle A

The charging executing unit 103 is configured to execute charging of the battery 52 of the electric vehicle A in accordance with the first charging plan for the electric vehicle A, and execute charging of the battery 52 of the electric vehicle B in accordance with the second charging plan for the electric vehicle B.

The communication I/F 2D of the charging apparatus 2 includes an input unit that enables an operator to enter a request to create a charging plan for each electric vehicle A, B.

Next, the following describes a charging plan creating routine based on the corresponding program instructions of the one or more programs stored in the memory device 2B according to the first embodiment using the flowchart of FIG. 2. For example, the CPU 2A is programmed to execute the charging plan creating routine in response to an operator's input of a charging plan creating request through the communication I/F 2D.

When starting the charging plan creating routine, the CPU 2A serves as the variation calculator 101 to read, from the traveling information storage 201, the first to tenth traveling information items IT1(i) to IT10(i) (see FIG. 3A) on the selected electric vehicle step S001.

Next, the CPU 2A serves as the variation calculator 101 to obtain, based on the first to tenth traveling information items IT1(i) to IT10(i), the first level of variation in the values of the energy-related parameter, i.e., the traveling energy or the at least one of the first to eighth influence factors, for the selected travel route ia of the electric vehicle A, and obtain, based on the first to tenth traveling information items IT1(i) to IT10(i), the second level of variation in the values of the energy-related parameter, i.e., the traveling energy or the at least one of the first to eighth influence factors, for the selected travel route ib of the electric vehicle B in step S002.

Specifically, in step S002, the CPU 2A serves as the variation calculator 101 to obtain, as the first level of variation in the values of the energy-related parameter for the selected travel route ia of the electric vehicle A, any one of
(I) The level of variation in the first to tenth values of the traveling energy TEV1(i=ia) to TEV10(i=ia) for the selected travel route ia of the electric vehicle A
(II) The level of variation in the first to tenth values of at least one of the first to eighth influence factors for the selected travel route ia of the electric vehicle A

For example, the CPU 2A serves as the variation calculator 101 to calculate a variance of the first to tenth values of the traveling energy TEV1(i=ia) to TEV10(i=ia) as the level of variation in the first to tenth values of the traveling energy TEV1(i=ia) to TEV10(i=ia) to accordingly calculate a variance σ(ia) of energy required for the electric vehicle A to travel along the selected travel route ia.

Alternatively, the CPU 2A serves as the variation calculator 101 to calculate, as the level of variation in the first to tenth values of at least one of the first to eighth influence factors, the variance σ(ia) of energy required for traveling of the electric vehicle A along the selected travel route ia based on a combination of selected two of the first to tenth influence factors in accordance with the following formula f01A:

$$σ ( ia ) = σ a 1 ( ia ) \times σ a 2 ( ia ) \qquad ( f01A )$$

where:
σa1(ia) represents a variance of a selected one of the first to tenth influence factors for the traveling of the electric vehicle A along the selected travel route ia; and
σa2(ia) represents a variance of a selected alternative one of the first to tenth influence factors for the traveling of the electric vehicle A along the selected travel route ia.

Similarly, in step S002, the CPU 2A serves as the variation calculator 101 to calculate, as the second level of variation in the values of the energy-related parameter for the selected travel route ib of the electric vehicle B, any one of
(I) The level of variation in the first to tenth values of the traveling energy TEV1(i=ib) to TEV10(i=ib) for the selected travel route ib of the electric vehicle B
(II) The level of variation in the first to tenth values of at least one of the first to eighth influence factors for the selected travel route ib of the electric vehicle B

For example, the CPU 2A serves as the variation calculator 101 to calculate a variance of the first to tenth values of the traveling energy TEV1(i=ib) to TEV10(i=ib) to accordingly calculate a variance σ(ib) of energy required for the electric vehicle B to travel along the selected travel route ib.

Alternatively, the CPU 2A serves as the variation calculator 101 to calculate, as the level of variation in the first to tenth values of at least one of the first to tenth influence factors, the variance σ(ib) of energy required for traveling of the electric vehicle B along the selected travel route ib based on a combination of selected two of the first to tenth influence factors in accordance with the following formula f01B:

$$σ ( ib ) = σ b 1 ( ib ) \times σ b 2 ( ib ) \qquad ( f01B )$$

where:
σb1(ib) represents a variance of a selected one of the first to tenth influence factors for the traveling of the electric vehicle B along the selected travel route ib; and
σb2(ib) represents a variance of a selected alternative one of the first to tenth influence factors for the traveling of the electric vehicle B along the selected travel route ib.

Following the operation in step S002, the CPU 2A serves as the charging plan creator 102 to read, from the traveling plan storage 202, the traveling plan for the electric vehicle A and the traveling plan for the electric vehicle B in step S003 (see FIGS. 3B and 3C).

Following the operation in step S003, the CPU 2A serves as the charging plan creator 102 to create the first charging plan for the electric vehicle A and the second charging plan for the electric vehicle B in accordance with (i) the traveling plan for the electric vehicle A stored in the traveling plan storage 202, (ii) the traveling plan for the electric vehicle B stored in the traveling plan storage 202, (iii) the first level of variation in the values of the energy-related parameter for the selected travel route ia of the electric vehicle A, and (iv) the second level of variation in the values of the energy-related parameter for the selected travel route ib of the electric vehicle B in step S004.

Specifically, the CPU 2A serves as the charging plan creator 102 to calculate, based on the present SOC of the battery 52 of the electric vehicle A, a predetermined base charging time T(ia) required to charge the battery 52 of the electric vehicle A up to a predetermined SOC that is required for the electric vehicle A to travel along the predetermined travel route ia, and calculate, based on the present SOC of the battery 52 of the electric vehicle B, a predetermined base charging time T(ib) required to charge the battery 52 of the electric vehicle B up to a predetermined SOC that is required for the electric vehicle B to travel along the predetermined travel route ib in step S004A1.

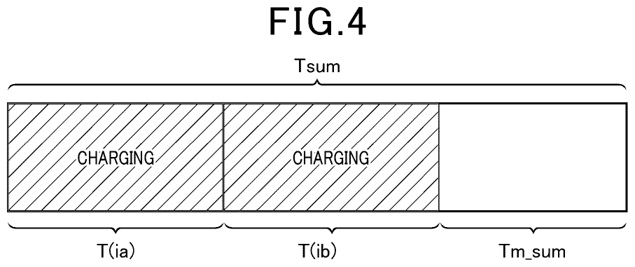

Then, the CPU 2A serves as the charging plan creator 102 to calculate, in step S004A2, a charging margin time Tm_sum in accordance with the following formula f02 (see FIG. 4):

$$Tm\_sum = Tsum - T ( ia ) - T ( ib ) \qquad ( f02 )$$

Next, the CPU 2A serves as the charging plan creator 102 to allocate the charging margin time Tm_sum to both the electric vehicle A and the electric vehicle B as their additional charging times Tm(ia) and Tm(ib) in accordance with the following formulas f03 and f04 in step S004A3:

$$Tm ( ia ) = Tm\_sum \times σ ( ia ) / \{ σ ( ia ) + σ ( ib ) \} \qquad ( f03 )$$

$$Tm ( ib ) = Tm\_sum \times σ ( ib ) / \{ σ ( ia ) + σ ( ib ) \} \qquad ( f04 )$$

where:
Tm_sum represents the charging margin time;
σ(ia) represents the variance of energy required for the electric vehicle A to travel along the selected travel route ia; and
σ(ib) represents the variance of energy required for the electric vehicle B to travel along the selected travel route ib.

Next, the CPU 2A serves as the charging plan creator 102 to calculate the first charging plan for the electric vehicle A as the sum of the base charging time T(ia) and the additional charging time Tm(ia), and calculate the second charging plan for the electric vehicle B as the sum of the base charging time T(ib) and the additional charging time Tm(ib) in step S004A4.

After the operation in step S004 (S004A4), the CPU 2A terminates the charging plan creating routine.

Thereafter, at desired timing, such as in response to an operator's input of a charging request through the communication I/F 2D, the CPU 2A serves as the charging executing unit 103 to execute charging of the battery 52 of the electric vehicle A in accordance with the first charging plan for the electric vehicle A, and execute charging of the battery 52 of the electric vehicle B in accordance with the second charging plan for the electric vehicle B in step S005. After completion of the charging of the battery 52 of each of the electric vehicles A and B, the CPU 2A terminates the operation in step S005.

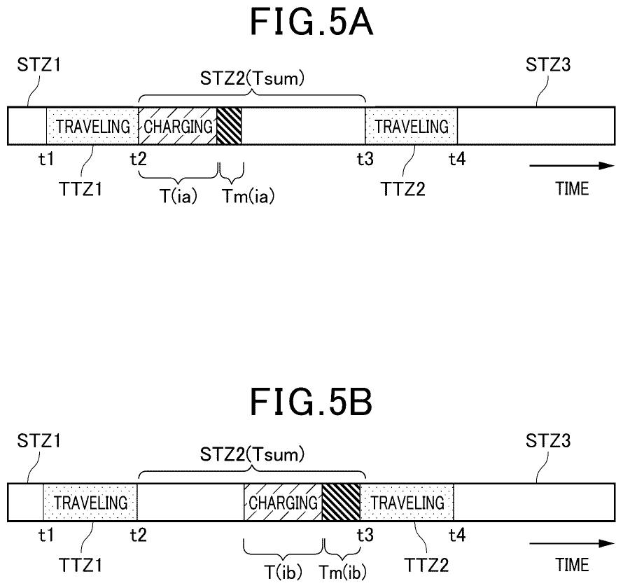

Specifically, FIG. 5A shows the first charging plan for the electric vehicle A as the sum of the base charging time T(ia) and the additional charging time Tm(ia), which is expressed by (T(ia)+Tm(ia)).

Similarly, FIG. 5B shows the second charging plan for the electric vehicle B as the sum of the base charging time T(ib) and the additional charging time Tm(ib), which is expressed by (T(ib)+Tm(ib)).

That is, as illustrated in FIGS. 5A and 5B, the charging apparatus 2 according to the first embodiment makes it possible to allocate the limited total chargeable time Tsum to the electric vehicles A and B such that
(I) The charging time allocated to the electric vehicle A is greater than the charging time allocated to the electric vehicle B upon determination that the variance σ(ia) of energy required for the electric vehicle A to travel along the selected travel route ia is greater than variance σ(ib) of energy required for the electric vehicle B to travel along the selected travel route ib
(II) The charging time allocated to the electric vehicle B is greater than the charging time allocated to the electric vehicle A upon determination that the variance σ(ib) of energy required for the electric vehicle B to travel along the selected travel route ib is greater than variance σ(ia) of energy required for the electric vehicle A to travel along the selected travel route ia

The charging plan creator 102 according to a modification of the first embodiment can be configured to allocate, in step S004A3, the charging margin time Tm_sum to the additional charging time Tm(ia) for the electric vehicle A and the additional charging time Tm(ib) for the electric vehicle B in accordance with
(I) The traveling plan for the electric vehicle A stored in the traveling plan storage 202
(II) The traveling plan for the electric vehicle B stored in the traveling plan storage 202
(III) The variance σ(ia) of energy required for the electric vehicle A to travel along the selected travel route ia
(IV) The variance σ(ib) of energy required for the electric vehicle B to travel along the selected travel route ib
(V) A predetermined base energy amount Ea required to charge the battery 52 of the electric vehicle A up to the predetermined SOC that is required for the electric vehicle A to travel along the predetermined travel route ia
(VI) A predetermined base energy amount Eb required to charge the battery 52 of the electric vehicle B up to the predetermined SOC that is required for the electric vehicle B to travel along the predetermined travel route ib

Specifically, the charging plan creator 102 can allocate the charging margin time Tm_sum to the additional charging time Tm(ia) for the electric vehicle A in accordance with the following formula f05 in step S004A3:

$$Tm ( ia ) = Tm\_sum \times σ ( ia ) / \{ σ ( ia ) + σ ( ib ) \} \times Ea / ( Ea + Eb ) \qquad ( f05 )$$

where:
Tm_sum represents the charging margin time;
σ(ia) represents the variance of energy required for the electric vehicle A to travel along the selected travel route ia;
σ(ib) represents the variance of energy required for the electric vehicle B to travel along the selected travel route ib;
Ea represents the base energy amount required to charge the battery 52 of the electric vehicle A up to the predetermined SOC that is required for the electric vehicle A to travel along the predetermined travel route ia; and
Eb represents the base energy amount required to charge the battery 52 of the electric vehicle B up to the predetermined SOC that is required for the electric vehicle B to travel along the predetermined travel route ib.

In step S004A3, the CPU 2A serves as the charging plan creator 102 to additionally allocate the charging margin time Tm_sum to the additional charging time Tm(ib) for the electric vehicle B in accordance with the following formula f06:

$$Tm ( ib ) = Tm\_sum \times σ ( ib ) / \{ σ ( ia ) + σ ( ib ) \} \times Eb / ( Ea + Eb ) \qquad ( f06 )$$

The charging apparatus 2 according to the modification of the first embodiment therefore makes it possible to allocate a greater amount of the limited total chargeable time Tsum to one of the electric vehicles A and B than to the other of the electric vehicles A and B if the variance of energy and the base energy amount for one of the electric vehicles A and B is greater than the other of the electric vehicles A and B.

### Second Embodiment

The following describes the second embodiment of the present disclosure.

The configuration of the charging apparatus 2 of the second embodiment is substantially identical to that of the charging apparatus 2 of the first embodiment except that the traveling energy information stored in the traveling information storage 201 of the second embodiment is different from the traveling energy information stored in the traveling information storage 201 of the first embodiment.

That is, let us assume that the plurality of electric vehicles will be referred to as electric vehicles j (j is an integer more than or equal to 2).

Specifically, the traveling information storage 201 of the second embodiment stores, for example, for each travel route i, the traveling energy information on each electric vehicle j.

The traveling energy information on each electric vehicle j for each travel route i includes values of traveling energy that were required for plural traveling actions of each electric vehicle j along the corresponding travel route i.

The values of the traveling energy of each electric vehicle j for each travel route i can be measured values that were actually used for plural traveling actions of the corresponding electric vehicle j along the corresponding travel route i, or can be predicted values that were predicted for plural traveling actions of the corresponding electric vehicle j along the corresponding travel route i.

Specifically, like the first embodiment, the traveling energy information on each electric vehicle j for each travel route i, which is comprised of, for example, first to tenth traveling information items, are stored in the traveling information storage 201. The first to tenth traveling information items on each electric vehicle j for each travel route i will be referred to as IT1(j, i) to IT10((j, i).

Specifically, in step S002, the CPU 2A serves as the variation calculator 101 to calculate, as the first level of variation in the values of the energy-related parameter for the selected travel route ia of the electric vehicle A, at least one of
(I) The level of variation in the first to tenth values of the traveling energy TEV1(j, i=ia) to TEV10(j, i=ia) for the traveling of each electric vehicle j along the selected travel route ia
(II) The level of variation in the first to tenth values of at least one of the first to tenth influence factors for the traveling of each electric vehicle j along the selected travel route ia

For example, the CPU 2A serves as the variation calculator 101 to calculate a variance of the first to tenth values of the traveling energy TEV1(j, i=ia) to TEV10(j, i=ia) as the level of variation in the first to tenth values of the traveling energy TEV1(i=ia) to TEV10(i=ia) variation to accordingly calculate a variance σ(j, ia) of energy required for each electric vehicle j to travel along the selected travel route ia.

Alternatively, the CPU 2A serves as the variation calculator 101 to calculate, as the level of variation in the first to tenth values of at least one of the first to tenth influence factors, the variance σ(j, ia) of energy required for traveling of each electric vehicle j along the selected travel route ia in accordance with the following formula f07A:

$$σ ( j , ia ) = σ a 1 ( j , ia ) \times σ a 2 ( j , ia ) \qquad ( f 07 A )$$

where:
σa1(j, ia) represents a variance of a selected one of the first to tenth influence factors for the traveling of each electric vehicle j along the selected travel route ia; and
σa2(j, ia) represents a variance of a selected alternative one of the first to tenth influence factors for the traveling of each electric vehicle j along the selected travel route ia.

Similarly, in step S002, the CPU 2A serves as the variation calculator 101 to calculate, as the second level of variation in the values of the energy-related parameter for the selected travel route ib of the electric vehicle B, any one of
(I) The level of variation in the first to tenth values of the traveling energy TEV1(j, i=ib) to TEV10(j, i=ib) for the traveling of each electric vehicle j along the selected travel route ib
(II) The level of variation in the first to tenth values of at least one of the first to eighth influence factors for the traveling of each electric vehicle j along the selected travel route ib

For example, the CPU 2A serves as the variation calculator 101 to calculate a variance of the first to tenth values of the traveling energy TEV1(j, i=ib) to TEV10(j, i=ib) to accordingly calculate a variance a(j, ib) of energy required for each electric vehicle j to travel along the selected travel route ib.

Alternatively, the CPU 2A serves as the variation calculator 101 to calculate, as the level of variation in the first to tenth values of at least one of the first to tenth influence factors, the variance σ(j, ib) of energy required for traveling of each electric vehicle j along the selected travel route ib based on a combination of selected two of the first to tenth influence factors in accordance with the following formula f07B:

$$σ ( j , ib ) = σ a 1 ( j , ib ) \times σ a 2 ( j , ib ) \qquad ( f 07 B )$$

where:
σa1(j, ib) represents a variance of a selected one of the first to tenth influence factors for the traveling of each electric vehicle j along the selected travel route ib; and
σa2(j, ib) represents a variance of a selected one of the first to tenth influence factors for the traveling of each electric vehicle j along the selected travel route b.

In step S004A3, the CPU 2A serves as the charging plan creator 102 to allocate the charging margin time Tm_sum to an additional charging time Tm(ia) for the electric vehicle A in accordance with the following formula f08:

$$Tm ( ia ) = Tm\_sum \times σ ( a , ia ) / \{ σ ( a , ia ) + σ ( b , ib ) \} \qquad ( f 08 )$$

where:
Tm_sum represents the charging margin time;
σ(a, ia) represents the variance of energy required for the electric vehicle A to travel along the selected travel route ia; and
σ(b, ib) represents the variance of energy required for the electric vehicle B to travel along the selected travel route ib.

In step S004A3, the CPU 2A serves as the charging plan creator 102 to allocate the charging margin time Tm_sum to an additional charging time Tm(ib) for the electric vehicle B in accordance with the following formula f09:

$$Tm ( ib ) = Tm\_sum \times σ ( b , ib ) / \{ σ ( a , ia ) + σ ( b , ib ) \} \qquad ( f 09 )$$

where:
σ(a, ia) represents the variance of energy required for the electric vehicle A to travel along the selected travel route ia; and
σ(b, ib) represents the variance of energy required for the electric vehicle B to travel along the selected travel route ib.

The charging apparatus 2 according to the second embodiment therefore makes it possible to allocate the limited total chargeable time Tsum to the electric vehicles A and B such that
(I) The charging time allocated to the electric vehicle A is greater than the charging time allocated to the electric vehicle B upon determination that the variance σ(a, ia) of energy required for the electric vehicle A to travel along the selected travel route ia is greater than variance σ(b, ib) of energy required for the electric vehicle B to travel along the selected travel route ib
(II) The charging time allocated to the electric vehicle B is greater than the charging time allocated to the electric vehicle A upon determination that the variance σ(b, ib) of energy required for the electric vehicle B to travel along the selected travel route ib is greater than variance σ(a, ia) of energy required for the electric vehicle A to travel along the selected travel route ia

The charging plan creator 102 according to a modification of the second embodiment can be configured to allocate, in step S004A3, the charging margin time Tm_sum to the additional charging time Tm(ia) for the electric vehicle A and the additional charging time Tm(ib) for the electric vehicle B in accordance with
(I) The traveling plan for the electric vehicle A stored in the traveling plan storage 202
(II) The traveling plan for the electric vehicle B stored in the traveling plan storage 202
(III) The variance σ(a, ia) of energy required for the electric vehicle A to travel along the selected travel route ia
(IV) The variance σ(b, ib) of energy required for the electric vehicle B to travel along the selected travel route ib
(V) The base energy amount Ea required to charge the battery 52 of the electric vehicle A up to the predetermined SOC that is required for the electric vehicle A to travel along the predetermined travel route ia
(VI) The base energy amount Eb required to charge the battery 52 of the electric vehicle B up to the predetermined SOC that is required for the electric vehicle B to travel along the predetermined travel route ib

Specifically, the charging plan creator 102 can allocate the charging margin time Tm_sum to the additional charging time Tm(ia) for the electric vehicle A in accordance with the following formula f10 in step S004A3:

$$Tm ( ia ) = Tm\_sum \times σ ( a , ia ) / \{ σ ( a , ia ) + σ ( b , ib ) \} \times Ea / ( Ea + Eb ) \qquad ( f10 )$$

where:
Tm_sum represents the charging margin time;
σ(a, ia) represents the variance of energy required for the electric vehicle A to travel along the selected travel route ia; and
σ(b, ib) represents the variance of energy required for the electric vehicle B to travel along the selected travel route ib;
Ea represents the base energy amount required to charge the battery 52 of the electric vehicle A up to the predetermined SOC that is required for the electric vehicle A to travel along the predetermined travel route ia; and
Eb represents the base energy amount required to charge the battery 52 of the electric vehicle B up to the predetermined SOC that is required for the electric vehicle B to travel along the predetermined travel route ib.

In step S004A3, the CPU 2A serves as the charging plan creator 102 to additionally allocate the charging margin time Tm_sum to the additional charging time Tm(ib) for the electric vehicle B in accordance with the following formula f11:

$$Tm ( ib ) = Tm\_sum \times σ ( b , ib ) / \{ σ ( a , ia ) + σ ( b , ib ) \} \times Eb / ( Ea + Eb ) \qquad ( f11 )$$

The charging apparatus 2 according to the modification of the second embodiment therefore makes it possible to allocate a greater amount of the limited total chargeable time Tsum to one of the electric vehicles A and B than to the other of the electric vehicles A and B if the variance of energy and the base energy amount for one of the electric vehicles A and B is greater than the other of the electric vehicles A and B.

### Third Embodiment

The following describes the third embodiment of the present disclosure.

The configuration of the charging apparatus 2 of the third embodiment is substantially identical to that of the charging apparatus 2 of the first embodiment except that the charging apparatus 2 is configured to calculate, as the level of variation in the energy-related parameter, a degree of energy prediction reliability for each travel route i.

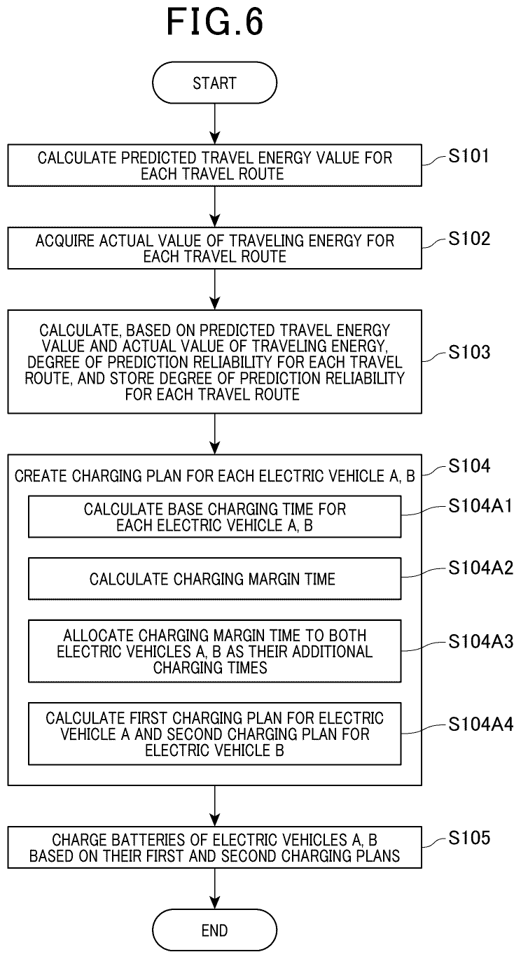

Specifically, the charging apparatus 2 of the third embodiment is perform, before the charging plan creating routine, a prediction reliability calculation routine for each travel route i illustrated in FIG. 6.

When starting the prediction reliability calculation routine, the CPU 2A serves as the variation calculator 101 to calculate a predicted traveling energy value based on the previously detected first to tenth values of the traveling energy TEV1(i) to TEV10(i) for each travel route i or a predicted value of a selected at least one of the first to eighth influence factors based on the previously detected first to tenth values of the selected at least one of the first to eighth influence factors in step S101 of FIG. 6.

For example, the variation calculator 101 may calculate an average value of the previously detected first to tenth values of the traveling energy TEV1(i) to TEV10(i) for each travel route i as the predicted traveling energy value for the corresponding travel route i. Alternatively, the variation calculator 101 may calculate an average value of the previously detected first to tenth values of the selected at least one of the first to eighth influence factors for each travel route i as the predicted value of the selected at least one of the first to eighth influence factors for the corresponding travel route i.

The predicted traveling energy value for each travel route i or the predicted value of the selected at least one of the first to eighth influence factors for each travel route i will be referred to as a predicted result Xprd(i).

Following the operation in step S101, the CPU 2A serves as the variation calculator 101 to acquire an actual value of the traveling energy required for an actual traveling of the at least one electric vehicle along each travel route i or an actual value of the selected at least one of the first to eighth influence factors required for an actual traveling of the at least one electric vehicle along each travel route i in step S102. For example, the sensors SS of the at least one electric vehicle can measure the actual traveling energy value required for the at least one electric vehicle to travel along each travel route i or measure the actual value of the selected at least one of the first to eighth influence factors during traveling of the at least one electric vehicle along each travel route i, and the CPU 2A can acquire, from the sensors SS of the selected electric vehicle, the actual traveling energy value for each travel route i or the actual value of the selected at least one of the first to eighth influence factors for each travel route i in step S102.

The actual traveling energy value required for the actual traveling of the at least one electric vehicle along each travel route i or the actual value of the selected at least one of the first to eighth influence factors required for the actual traveling of the at least one electric vehicle along each travel route i will be referred to as an actual measurement result Xmes(i).

Note that, if the predicted traveling energy value for each travel route i is selected as the predicted result Xprd(i), the actual traveling energy value for each travel route i is selected as the actual measurement result Xmes(i). Otherwise, if the predicted value of the selected at least one of the first to eighth influence factors for each travel route i is selected as the predicted result Xprd(i), the actual value of the selected at least one of the first to eighth influence factors for each travel route i is selected as the actual measurement result Xmes(i).

Following the operation in step S102, the CPU 2A serves as the variation calculator 101 to calculate a degree of prediction reliability R(i) for each travel route i in accordance with the following formula (f12) in step S103:

$$R ( i ) = Xprd ( i ) / Xmes ( i ) \qquad ( f12 )$$

That is, the degree of prediction reliability R(i) for each travel route i represents a degree of deviation between the predicted result Xprd(i) and the actual measurement result Xmes(i) for the corresponding travel route i.

Then, the CPU 2A serves as the variation calculator 101 to store the degree of prediction reliability R(i) for each travel route i in the traveling information storage 201 in step S103.

Following the operation in step S103, the CPU 2A serves as the charging plan creator 102 to create, like the operation in step S004, the first charging plan for the electric vehicle A and the second charging plan for the electric vehicle B in accordance with (i) the traveling plan for the electric vehicle A stored in the traveling plan storage 202, (ii) the traveling plan for the electric vehicle B stored in the traveling plan storage 202, and (iii) the degree of prediction reliability R(i) for each travel route i in step S104 (see FIG. 4).

Specifically, the CPU 2A serves as the charging plan creator 102 to calculate, like the operation in step S004A1, the base charging time T(ia) of the electric vehicle A and the base charging time T(ib) of the electric vehicle B in step S104A1, and calculate, like the operation in step S004A2, the charging margin time Tm_sum in accordance with the above formula f02 in step S104A2.

Next, the CPU 2A serves as the charging plan creator 102 to allocate the charging margin time Tm_sum to both the electric vehicle A and the electric vehicle B as their additional charging times Tm(ia) and Tm(ib) in accordance with the following formulas f13 and f14 in step S104A3:

$$T m ( i a ) = Tm\_sum \times R ( ib ) / \{ R ( i a ) + R ( i b ) \} \qquad ( f13 )$$

$$Tm ( i b ) = Tm\_sum \times R ( ia ) / \{ R ( i a ) + R ( i b ) \} \qquad ( f14 )$$

where:
Tm_sum represents the charging margin time;
R(ia) represents the degree of prediction reliability for the selected travel route ia; and
R(ib) represents the degree of prediction reliability for the selected travel route ib

Next, like the operation in step S004A4, the CPU 2A serves as the charging plan creator 102 to calculate the first charging plan for the electric vehicle A as the sum of the base charging time T(ia) and the additional charging time Tm(ia), and calculate the second charging plan for the electric vehicle B as the sum of the base charging time T(ib) and the additional charging time Tm(ib) in step S104A4.

After the operation in step S104(S104A4), the CPU 2A terminates the charging plan creating routine.

Thereafter, at desired timing, such as in response to an operator's input of a charging request through the communication I/F 2D, the CPU 2A serves as the charging executing unit 103 to execute charging of the battery 52 of the electric vehicle A in accordance with the first charging plan for the electric vehicle A, and execute charging of the battery 52 of the electric vehicle B in accordance with the second charging plan for the electric vehicle B in step S105. Thereafter, the CPU 2A terminates the charging plan creating routine.

Specifically, FIG. 5A shows the first charging plan for the electric vehicle A as the sum of the base charging time T(ia) and the additional charging time Tm(ia), which is expressed by (T(ia)+Tm(ia)).

Similarly, FIG. 5B shows the second charging plan for the electric vehicle B as the sum of the base charging time T(ib) and the additional charging time Tm(ib), which is expressed by (T(ib)+Tm(ib)).

That is, as illustrated in FIGS. 5A and 5B, the charging apparatus 2 according to the first embodiment makes it possible to allocate the limited total chargeable time Tsum to the electric vehicles A and B such that
(I) The charging time allocated to the electric vehicle A is greater than the charging time allocated to the electric vehicle B upon determination that the degree of prediction reliability R(ib) for the selected travel route ib is higher than the degree of prediction reliability R(ia) for the selected travel route ia
(II) The charging time allocated to the electric vehicle B is greater than the charging time allocated to the electric vehicle A upon determination that the degree of prediction reliability R(ia) for the selected travel route ia is higher than the degree of prediction reliability R(ib) for the selected travel route ib

That is, allocation of the total chargeable time Tsum to one of the electric vehicles A and B is greater than that of the total chargeable time Tsum to the other of the electric vehicles A and B as long as the degree of prediction reliability of the travel route of the one of the electric vehicles A and B is lower than that of the travel route of the other of the electric vehicles A and B. This is because, the higher the degree of prediction reliability for each travel route i, the smaller the level of variation in the values of the energy-related parameter for the corresponding travel route i, and the lower the degree of prediction reliability for each travel route i, the greater the level of variation in the values of the energy-related parameter for the corresponding travel route i.

The charging plan creator 102 according to a modification of the third embodiment can be configured to allocate, in step S104A3, the charging margin time Tm_sum to the additional charging time Tm(ia) for the electric vehicle A and the additional charging time Tm(ib) for the electric vehicle B in accordance with
(I) The traveling plan for the electric vehicle A stored in the traveling plan storage 202
(II) The traveling plan for the electric vehicle B stored in the traveling plan storage 202
(III) The degree of prediction reliability R(ia) for the selected travel route ia;
(IV) The degree of prediction reliability R(ib) for the selected travel route ib
(V) The energy amount Ea required to charge the battery 52 of the electric vehicle A up to the predetermined SOC that is required for the electric vehicle A to travel along the predetermined travel route ia
(VI) The base energy amount Eb required to charge the battery 52 of the electric vehicle B up to the predetermined SOC that is required for the electric vehicle B to travel along the predetermined travel route ib

Specifically, the charging plan creator 102 can allocate the charging margin time Tm_sum to the additional charging time Tm(ia) for the electric vehicle A in accordance with the following formula f15 in step S104A3:

$$T m ( i a ) = Tm\_sum \times \{ Ea / ( Ea + E b ) \} \times R ( ib ) / \{ R ( i a ) + R ( i b ) \} \qquad ( f15 )$$

where:
Tm_sum represents the charging margin time;
R(ia) represents the degree of prediction reliability for the selected travel route ia;
R(ib) represents the degree of prediction reliability for the selected travel route ib
Ea represents the base energy amount required to charge the battery 52 of the electric vehicle A up to the predetermined SOC that is required for the electric vehicle A to travel along the predetermined travel route ia; and
Eb represents the base energy amount required to charge the battery 52 of the electric vehicle B up to the predetermined SOC that is required for the electric vehicle B to travel along the predetermined travel route ib.

In step S104A3, the CPU 2A serves as the charging plan creator 102 to additionally allocate the charging margin time Tm_sum to the additional charging time Tm(ib) for the electric vehicle B in accordance with the following formula f16:

$$T m ( i b ) = Tm\_sum \times \{ Eb / ( Ea + E b ) \} \times R ( ia ) / \{ R ( i a ) + R ( i b ) \} \qquad ( f16 )$$

The charging apparatus 2 according to the modification of the third embodiment therefore makes it possible to allocate a greater amount of the limited total chargeable time Tsum to one of the electric vehicles A and B than to the other of the electric vehicles A and B if the variance of energy and the base energy amount for one of the electric vehicles A and B is greater than the other of the electric vehicles A and B.

### Fourth Embodiment

The following describes the fourth embodiment of the present disclosure.

The configuration of the charging apparatus 2 of the fourth embodiment is substantially identical to that of the charging apparatus 2 of the third embodiment except that the traveling energy information stored in the traveling information storage 201 of the fourth embodiment is different from the traveling energy information stored in the traveling information storage 201 of the third embodiment.

That is, let us assume that the plurality of electric vehicles will be referred to as electric vehicles j (j is an integer more than or equal to 2). the traveling information storage 201 of the fourth embodiment stores, for example, for each travel route i, the traveling energy information on each electric vehicle j.

The traveling energy information on each electric vehicle j for each travel route i includes values of traveling energy that were required for plural traveling actions of each electric vehicle j along the corresponding travel route i.

The values of the traveling energy of each electric vehicle j for each travel route i can be measured values that were actually used for plural traveling actions of the corresponding electric vehicle j along the corresponding travel route i, or can be predicted values that were predicted for plural traveling actions of the corresponding electric vehicle j along the corresponding travel route i.

The traveling energy information on each electric vehicle j for each travel route i, which is comprised of, for example, first to tenth traveling information items, are stored in the traveling information storage 201. The first to tenth traveling information items on each electric vehicle j for each travel route i will be referred to as IT1(j, i) to IT10((j, i).

Specifically, in step S101, the CPU 2A serves as the variation calculator 101 to calculate a predicted traveling energy value based on the previously detected first to tenth values of the traveling energy TEV1(j, i) to TEV10(j, i) for the traveling of each electric vehicle j along each travel route i or a predicted value of a selected at least one of the first to eighth influence factors based on the previously detected first to tenth values of the selected at least one of the first to eighth influence factors for the traveling of each electric vehicle j along each travel route i.

The predicted traveling energy value for the traveling of each electric vehicle j along each travel route i or the predicted value of the selected at least one of the first to eighth influence factors for the traveling of each electric vehicle j along each travel route i will be referred to as a predicted result Xprd(j, i).

Following the operation in step S101, the CPU 2A serves as the variation calculator 101 to acquire an actual value of the traveling energy required for an actual traveling of each electric vehicle j along each travel route i or an actual value of the selected at least one of the first to eighth influence factors required for an actual traveling of each electric vehicle j along each travel route i in step S102.

The actual traveling energy value required for the actual traveling of each electric vehicle j along each travel route i or the actual value of the selected at least one of the first to eighth influence factors required for the actual traveling of each electric vehicle j along each travel route i will be referred to as an actual measurement result Xmes(j, i).

Note that, if the predicted traveling energy value for each electric vehicle j and for each travel route i is selected as the predicted result Xprd(j, i), the actual traveling energy value for each electric vehicle j and for each travel route i is selected as the actual measurement result Xmes(j, i). Otherwise, if the predicted value of the selected at least one of the first to eighth influence factors for each electric vehicle j and for each travel route i is selected as the predicted result Xprd(j, i), the actual value of the selected at least one of the first to eighth influence factors for each electric vehicle j and for each travel route i is selected as the actual measurement result Xmes(j, i).

Following the operation in step S102, the CPU 2A serves as the variation calculator 101 to calculate a degree of prediction reliability RU, i) for each electric vehicle j and for each travel route i in accordance with the following formula (f17) in step S103:

$$R ( j , i ) = Xprd ( j , i ) / Xmes ( j , i ) \qquad ( f17 )$$

Then, the CPU 2A serves as the variation calculator 101 to store the degree of prediction reliability R(j, i) for each electric vehicle j and for each travel route i in the traveling information storage 201 in step S103.

Following the operation in step S103, the CPU 2A serves as the charging plan creator 102 to create, like the operation in step S004, the first charging plan for the electric vehicle A and the second charging plan for the electric vehicle B in accordance with (i) the traveling plan for the electric vehicle A stored in the traveling plan storage 202, (ii) the traveling plan for the electric vehicle B stored in the traveling plan storage 202, and (iii) the degree of prediction reliability R(j, i) for each electric vehicle j and for each travel route i in step S104.

Specifically, in step S104A3, the CPU 2A serves as the charging plan creator 102 to allocate the charging margin time Tm_sum to the additional charging time Tm(ia) for the electric vehicle A in accordance with the following formula f18:

$$Tm ( ia ) = Tm\_sum \times R ( b , ib ) / \{ R ( a , ia ) + R ( b , ib ) \} \qquad ( f18 )$$

where:
Tm_sum represents the charging margin time;
R(a, ia) represents the degree of prediction reliability for the electric vehicle A and for the selected travel route ia; and
R(b, ib) represents the degree of prediction reliability for the electric vehicle B and for the selected travel route ib.

In step S104A3, the CPU 2A serves as the charging plan creator 102 to allocate the charging margin time Tm_sum to the additional charging time Tm(ib) for the electric vehicle B in accordance with the following formula f19:

$$Tm ( ib ) = Tm\_sum \times R ( a , ia ) / \{ R ( a , ia ) + R ( b , ib ) \} \qquad ( f19 )$$

where:
R(a, ia) represents the degree of prediction reliability for the electric vehicle A and for the selected travel route ia; and
R(b, ib) represents the degree of prediction reliability for the electric vehicle B and for the selected travel route ib.

The charging apparatus 2 according to the fourth embodiment therefore makes it possible to allocate the limited total chargeable time Tsum to the electric vehicles A and B such that
(I) The charging time allocated to the electric vehicle A is greater than the charging time allocated to the electric vehicle B upon determination that the degree of prediction reliability R(b, ib) for the electric vehicle B and for the selected travel route ib is higher than the degree of prediction reliability R(a, ia) for the electric vehicle A and for the selected travel route ia
(II) The charging time allocated to the electric vehicle B is greater than the charging time allocated to the electric vehicle A upon determination that the degree of prediction reliability R(a, ia) for the electric vehicle A and for the selected travel route ia is higher than the degree of prediction reliability R(b, ib) for the electric vehicle B and for the selected travel route ib

The charging plan creator 102 according to a modification of the fourth embodiment can be configured to allocate, in step S104A3, the charging margin time Tm_sum to the additional charging time Tm(ia) for the electric vehicle A and the additional charging time Tm(ib) for the electric vehicle B in accordance with
(I) The traveling plan for the electric vehicle A stored in the traveling plan storage 202
(II) The traveling plan for the electric vehicle B stored in the traveling plan storage 202
(III) The degree of prediction reliability R(a, ia) for the electric vehicle A and for the selected travel route ia;
(IV) The degree of prediction reliability R(b, ib) for the electric vehicle B and for the selected travel route ib;
(V) The base energy amount Ea required to charge the battery 52 of the electric vehicle A up to the predetermined SOC that is required for the electric vehicle A to travel along the predetermined travel route ia
(VI) The base energy amount Eb required to charge the battery 52 of the electric vehicle B up to the predetermined SOC that is required for the electric vehicle B to travel along the predetermined travel route ib

Specifically, the charging plan creator 102 can allocate the charging margin time Tm_sum to the additional charging time Tm(ia) for the electric vehicle A in accordance with the following formula f20 in step S104A3:

$$Tm ( ia ) = Tm\_sum \times \{ Ea / ( Ea + E b ) \} \times R ( b , ib ) / \{ R ( a , ia ) + R ( b , ib ) \} \qquad ( f20 )$$

where:
Tm_sum represents the charging margin time;
R(a, ia) represents the degree of prediction reliability for the electric vehicle A and for the selected travel route ia;
R(b, ib) represents the degree of prediction reliability for the electric vehicle B and for the selected travel route ib;
Ea represents the base energy amount required to charge the battery 52 of the electric vehicle A up to the predetermined SOC that is required for the electric vehicle A to travel along the predetermined travel route ia; and
Eb represents the base energy amount required to charge the battery 52 of the electric vehicle B up to the predetermined SOC that is required for the electric vehicle B to travel along the predetermined travel route ib.

In step S004A3, the CPU 2A serves as the charging plan creator 102 to additionally allocate the charging margin time Tm_sum to the additional charging time Tm(ib) for the electric vehicle B in accordance with the following formula f21:

$$Tm ( ib ) = Tm\_sum \times \{ Eb / ( Ea + E b ) \} \times R ( a , ia ) / \{ R ( a , ia ) + R ( b , ib ) \} \qquad ( f21 )$$

The charging apparatus 2 according to the modification of the fourth embodiment therefore makes it possible to allocate a greater amount of the limited total chargeable time Tsum to one of the electric vehicles A and B than to the other of the electric vehicles A and B if the variance of energy and the base energy amount for one of the electric vehicles A and B is greater than the other of the electric vehicles A and B.

The present disclosure includes the following first to eleventh technological concepts.

The first technological concept is a charging plan creating apparatus (2). The charging plan creating apparatus (2) includes a variation calculator (101) configured to calculate, based on information on traveling energy required for a traveling of at least one electric vehicle along each of a plurality of travel routes, a level of energy variation in one of (i) values of the traveling energy required for the traveling of the at least one electric vehicle along each of the plurality of travel routes, and (ii) values of at least one influence factor for each of the plurality of travel routes. The at least one influence factor influences the traveling energy.

The charging plan creating apparatus (2) includes a charging plan creator (102) configured to obtain the level of energy variation for a first travel route included in the plurality of travel routes as a first level of energy variation, and obtain the level of energy variation for a second travel route included in the plurality of travel routes as a second level of energy variation.

The charging plan creator (102) is configured to allocate, based on a common stop time of both the first and second electric vehicles included in first and second traveling plans for the respective first and second electric vehicles, a usable charging time to the first and second electric vehicles in accordance with a comparison between the first level of energy variation for the first travel route and the second level of energy variation for the second travel route to accordingly create first and second charging plans for the respective first and second electric vehicles.

In the second technological concept, which depends from the first technological concept, the charging plan creator is configured to determine allocation of the usable charging time to the first and second electric vehicles such that
(I) A first charging time included in the usable charging time and allocated to the first electric vehicle is greater than a second charging time included in the usable charging time and allocated to the second electric vehicle upon determination that the first level of energy variation for the first travel route is greater than the second level of energy variation for the second travel route
(II) The second charging time included in the usable charging time and allocated to the second electric vehicle is greater than the first charging time included in the usable charging time and allocated to the first electric vehicle upon determination that the second level of energy variation for the second travel route is greater than the first level of energy variation for the first travel route

In the third technological concept, which depends from the first technological concept, the variation calculator is configured to calculate, as the level of energy variation for each of the plurality of travel routes, a level energy-value variation in the values of the traveling energy required for the traveling of the at least one electric vehicle along the corresponding one of the plurality of travel routes.

The charging plan creator is configured to obtain the level of energy-value variation for the first travel route as a first level of energy-value variation, and obtain the level of energy-value variation for the second travel route as a second level of energy-value variation.

The charging plan creator is configured to determine allocation of the usable charging time to the first and second electric vehicles such that
(I) The first charging time included in the usable charging time and allocated to the first electric vehicle is greater than the second charging time included in the usable charging time and allocated to the second electric vehicle upon determination that the first level of energy-value variation is greater than the second level of energy-value variation
(II) The second charging time included in the usable charging time and allocated to the second electric vehicle is greater than the first charging time included in the usable charging time and allocated to the first electric vehicle upon determination that the second level of energy-value variation is greater than the first level of energy-value variation

In the fourth technological concept, which depends from any one of the first to third technological concepts, the values of the traveling energy required for the traveling of the at least one electric vehicle along each of the plurality of travel routes include one of (i) measured values of the traveling energy actually used the traveling of the at least one electric vehicle along the corresponding one of the plurality of travel routes and (ii) predicted values of the traveling energy required for the traveling of the at least one electric vehicle along the corresponding one of the plurality of travel routes.

The at least one influence factor for each of the plurality of travel routes includes
(I) A first energy influence factor indicative of a distance traveled by the at least one electric vehicle along the corresponding one of the plurality of travel routes
(II) A second energy influence factor indicative of a time required for the traveling of the at least one electric vehicle along the corresponding one of the plurality of travel routes
(III) A third energy influence factor indicative of a traffic situation of the corresponding one of the plurality of travel routes during the traveling of the at least one electric vehicle along the corresponding one of the plurality of travel routes
(IV) A fourth energy influence factor indicative of the number of stops of the at least one electric vehicle along the corresponding one of the plurality of travel routes
(V) A fifth energy influence factor indicative of an average speed of the at least one electric vehicle during the traveling of the at least one electric vehicle along the corresponding one of the plurality of travel routes
(VI) A sixth energy influence factor indicative of the number of driver changes of the at least one electric vehicle during the traveling of the at least one electric vehicle along the corresponding one of the plurality of travel routes
(VII) A seventh energy influence factor indicative of variations of driving operations of the at least one electric vehicle during the traveling of the at least one electric vehicle along the corresponding one of the plurality of travel routes
(VIII) An eighth energy influence factor indicative of a weather condition during the traveling of the at least one electric vehicle along the corresponding one of the plurality of travel routes

In the fifth technological concept, which depends from the first technological concept, the variation calculator is configured to calculate, as the level of energy variation, an energy variance in one of (i) the values of the traveling energy required for the traveling of the at least one electric vehicle along each of the plurality of travel routes, and (ii) the values of the at least one influence factor for each of the plurality of travel routes.

The charging plan creator is configured to obtain the energy variance for the first travel route as a first energy variance, and obtain the energy variance for the second travel route as a second energy variance.

The charging plan creator is configured to determine allocation of the usable charging time to the first and second electric vehicles such that
(I) The first charging time included in the usable charging time and allocated to the first electric vehicle is greater than the second charging time included in the usable charging time and allocated to the second electric vehicle upon determination that the first energy variance for the first travel route is greater than the second energy variance for the second travel route
(II) The second charging time included in the usable charging time and allocated to the second electric vehicle is greater than the first charging time included in the usable charging time and allocated to the first electric vehicle upon determination that the second energy variance for the second travel route is greater than the first energy variance for the first travel route.

In the sixth technological concept, which depends from the first technological concept, the at least one electric vehicle includes a plurality of electric vehicles, and the variation calculator is configured to calculate the level of energy variation in one of (i) the values of the traveling energy required for the traveling of each of the electric vehicles along each of the plurality of travel routes, and (ii) the values of the at least one influence factor for each of the plurality of travel routes.

In the seventh technological concept, which depends from the sixth technological concept, the variation calculator is configured to calculate, as the level of energy variation, an energy variance in one of: (i) the values of the traveling energy required for the traveling of each of the plurality of electric vehicles along each of the plurality of travel routes, and (ii) the values of the at least one influence factor for each of the plurality of travel routes.

In the eighth technological concept, which depends from the first technological concept, the variation calculator is configured to calculate a predicted energy parameter for each of the plurality of travel routes based on one of (i) the values of the traveling energy required for the traveling of the at least one electric vehicle along the corresponding one of the plurality of travel routes, and (ii) the values of the at least one influence factor for the corresponding one of the plurality of travel routes.

The variation calculator is configured to calculate an actual measurement energy parameter for each of the plurality of travel routes based on one of: (i) actually measured values of the traveling energy required for the traveling of the at least one electric vehicle along the corresponding one of the plurality of travel routes, and (ii) actually measured values of the at least one influence factor for the corresponding one of the plurality of travel routes.

The variation calculator is configured to calculate a deviation between the predicted energy parameter and the actual measurement energy parameter for each of the plurality of travel routes, and calculate, as the level of energy variation for each of the plurality of travel routes, the deviation between the predicted energy parameter and the actual measurement energy parameter for the corresponding one of the plurality of travel routes.

In the ninth technological concept, which depends from the eighth technological concept, the at least one electric vehicle includes a plurality of electric vehicles. The variation calculator is configured to calculate the predicted energy parameter for each of the plurality of travel routes based on one of: (i) the values of the traveling energy required for the traveling of each of the plurality of electric vehicle along the corresponding one of the plurality of travel routes, and (ii) the values of the at least one influence factor for the corresponding one of the plurality of travel routes.

The variation calculator is configured to calculate the actual measurement energy parameter for each of the plurality of travel routes based on one of: (i) actually measured values of the traveling energy required for the traveling of each of the plurality of electric vehicles along the corresponding one of the plurality of travel routes, and (ii) actually measured values of the at least one influence factor for the corresponding one of the plurality of travel routes.

The tenth technological concept is a charging apparatus that includes a charging plan creating apparatus according to any one of the first to ninth technological concepts, and a charging executing unit (103) configured to execute charging of a battery of the first electric vehicle in accordance with the first charging plan for the first electric vehicle, and execute charging of a battery of the second electric vehicle in accordance with the second charging plan for the second electric vehicle.

The eleventh technological concept is a charging program product for at least one processor. The program product includes a non-transitory computer-readable storage medium, and a set of computer program instructions stored in the computer-readable storage medium.

The instructions cause the at least one processor to
(I) Calculate, based on information on traveling energy required for a traveling of at least one electric vehicle along each of a plurality of travel routes, a level of energy variation in one of: (i) values of the traveling energy required for the traveling of the at least one electric vehicle along each of the plurality of travel routes, and (ii) values of at least one influence factor for each of the plurality of travel routes, the at least one influence factor influencing the traveling energy
(II) Obtain the level of energy variation for a first travel route included in the plurality of travel routes as a first level of energy variation
(III) Obtain the level of energy variation for a second travel route included in the plurality of travel routes as a second level of energy variation
(IV) Allocate, based on a common stop time of both the first and second electric vehicles included in first and second traveling plans for the respective first and second electric vehicles, a usable charging time to the first and second electric vehicles in accordance a comparison between the first level of energy variation for the first travel route and the second level of energy variation for the second travel route to accordingly create first and second charging plans for the respective first and second electric vehicles.

The charging apparatuses and their charging methods disclosed in the present disclosure can be implemented by a dedicated computer including a memory and a processor programmed to perform one or more functions embodied by one or more computer programs.

The charging apparatuses and their charging methods disclosed in the present disclosure can also be implemented by a dedicated computer including a processor comprised of one or more dedicated hardware logic circuits.

The charging apparatuses and their charging methods disclosed in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor.

The present disclosure, which has been set forth above, is not limited to the above exemplary embodiments.

Each of the exemplary embodiments, whose design has been appropriately modified by a skilled person in the art, is included within the scope of the present disclosure as long as each of the design-modified exemplary embodiments includes the above features disclosed in the present disclosure.

Each component included in the charging apparatus according to each exemplary embodiment is not limited to the corresponding disclosure described in the corresponding exemplary embodiment, and therefore is appropriately modified. For example, the arrangement, characteristics, and shape of each component included in the charging apparatus according to each exemplary embodiment is not limited to the corresponding disclosed arrangement, characteristics, and shape in the corresponding exemplary embodiment, and therefore are appropriately modified.

The combination of the components included in the charging apparatus according to each exemplary embodiment can be changed to various combinations as long as there are no technological contradictions in the changed combinations.

1. A charging plan creating apparatus comprising:
a variation calculator configured to calculate, based on information on traveling energy required for a traveling of at least one electric vehicle along each of a plurality of travel routes, a level of energy variation in one of:
(i) values of the traveling energy required for the traveling of the at least one electric vehicle along each of the plurality of travel routes; and
(ii) values of at least one influence factor for each of the plurality of travel routes, the at least one influence factor influencing the traveling energy; and
a charging plan creator configured to:
obtain the level of energy variation for a first travel route included in the plurality of travel routes as a first level of energy variation;
obtain the level of energy variation for a second travel route included in the plurality of travel routes as a second level of energy variation; and
allocate, based on a common stop time of both the first and second electric vehicles included in first and second traveling plans for the respective first and second electric vehicles, a usable charging time to the first and second electric vehicles in accordance with a comparison between the first level of energy variation for the first travel route and the second level of energy variation for the second travel route to accordingly create first and second charging plans for the respective first and second electric vehicles.

2. The charging plan creating apparatus according to claim 1, wherein:
the charging plan creator is configured to determine allocation of the usable charging time to the first and second electric vehicles such that:
a first charging time included in the usable charging time and allocated to the first electric vehicle is greater than a second charging time included in the usable charging time and allocated to the second electric vehicle upon determination that the first level of energy variation for the first travel route is greater than the second level of energy variation for the second travel route; and
the second charging time included in the usable charging time and allocated to the second electric vehicle is greater than the first charging time included in the usable charging time and allocated to the first electric vehicle upon determination that the second level of energy variation for the second travel route is greater than the first level of energy variation for the first travel route.

3. The charging plan creating apparatus according to claim 1, wherein:
the variation calculator is configured to calculate, as the level of energy variation for each of the plurality of travel routes, a level energy-value variation in the values of the traveling energy required for the traveling of the at least one electric vehicle along the corresponding one of the plurality of travel routes; and
the charging plan creator is configured to:
obtain the level of energy-value variation for the first travel route as a first level of energy-value variation;
obtain the level of energy-value variation for the second travel route as a second level of energy-value variation; and
determine allocation of the usable charging time to the first and second electric vehicles such that:
the first charging time included in the usable charging time and allocated to the first electric vehicle is greater than the second charging time included in the usable charging time and allocated to the second electric vehicle upon determination that the first level of energy-value variation is greater than the second level of energy-value variation; and
the second charging time included in the usable charging time and allocated to the second electric vehicle is greater than the first charging time included in the usable charging time and allocated to the first electric vehicle upon determination that the second level of energy-value variation is greater than the first level of energy-value variation.

4. The charging plan creating apparatus according to claim 1, wherein:
the values of the traveling energy required for the traveling of the at least one electric vehicle along each of the plurality of travel routes include one of (i) measured values of the traveling energy actually used the traveling of the at least one electric vehicle along the corresponding one of the plurality of travel routes and (ii) predicted values of the traveling energy required for the traveling of the at least one electric vehicle along the corresponding one of the plurality of travel routes; and
the at least one influence factor for each of the plurality of travel routes includes:
a first energy influence factor indicative of a distance traveled by the at least one electric vehicle along the corresponding one of the plurality of travel routes;
a second energy influence factor indicative of a time required for the traveling of the at least one electric vehicle along the corresponding one of the plurality of travel routes;
a third energy influence factor indicative of a traffic situation of the corresponding one of the plurality of travel routes during the traveling of the at least one electric vehicle along the corresponding one of the plurality of travel routes;
a fourth energy influence factor indicative of the number of stops of the at least one electric vehicle along the corresponding one of the plurality of travel routes;
a fifth energy influence factor indicative of an average speed of the at least one electric vehicle during the traveling of the at least one electric vehicle along the corresponding one of the plurality of travel routes;
a sixth energy influence factor indicative of the number of driver changes of the at least one electric vehicle during the traveling of the at least one electric vehicle along the corresponding one of the plurality of travel routes;
a seventh energy influence factor indicative of variations of driving operations of the at least one electric vehicle during the traveling of the at least one electric vehicle along the corresponding one of the plurality of travel routes; and
an eighth energy influence factor indicative of a weather condition during the traveling of the at least one electric vehicle along the corresponding one of the plurality of travel routes.

5. The charging plan creating apparatus according to claim 1, wherein:
the variation calculator is configured to calculate, as the level of energy variation, an energy variance in one of:
(i) the values of the traveling energy required for the traveling of the at least one electric vehicle along each of the plurality of travel routes; and
(ii) the values of the at least one influence factor for each of the plurality of travel routes;
the charging plan creator is configured to
obtain the energy variance for the first travel route as a first energy variance;
obtain the energy variance for the second travel route as a second energy variance; and
determine allocation of the usable charging time to the first and second electric vehicles such that:
the first charging time included in the usable charging time and allocated to the first electric vehicle is greater than the second charging time included in the usable charging time and allocated to the second electric vehicle upon determination that the first energy variance for the first travel route is greater than the second energy variance for the second travel route; and
the second charging time included in the usable charging time and allocated to the second electric vehicle is greater than the first charging time included in the usable charging time and allocated to the first electric vehicle upon determination that the second energy variance for the second travel route is greater than the first energy variance for the first travel route.

6. The charging plan creating apparatus according to claim 1, wherein:
the at least one electric vehicle comprises a plurality of electric vehicles; and
the variation calculator is configured to calculate the level of energy variation in one of
(i) the values of the traveling energy required for the traveling of each of the electric vehicles along each of the plurality of travel routes; and
(ii) the values of the at least one influence factor for each of the plurality of travel routes.

7. The charging plan creating apparatus according to claim 6, wherein:
the variation calculator is configured to calculate, as the level of energy variation, an energy variance in one of:
(i) the values of the traveling energy required for the traveling of each of the plurality of electric vehicles along each of the plurality of travel routes; and
(ii) the values of the at least one influence factor for each of the plurality of travel routes.

8. The charging plan creating apparatus according to claim 1, wherein:
the variation calculator is configured to:
calculate a predicted energy parameter for each of the plurality of travel routes based on one of:
(i) the values of the traveling energy required for the traveling of the at least one electric vehicle along the corresponding one of the plurality of travel routes; and
(ii) the values of the at least one influence factor for the corresponding one of the plurality of travel routes;
calculate an actual measurement energy parameter for each of the plurality of travel routes based on one of:
(i) actually measured values of the traveling energy required for the traveling of the at least one electric vehicle along the corresponding one of the plurality of travel routes; and
(ii) actually measured values of the at least one influence factor for the corresponding one of the plurality of travel routes;
calculate a deviation between the predicted energy parameter and the actual measurement energy parameter for each of the plurality of travel routes; and
calculate, as the level of energy variation for each of the plurality of travel routes, the deviation between the predicted energy parameter and the actual measurement energy parameter for the corresponding one of the plurality of travel routes.

9. The charging plan creating apparatus according to claim 8, wherein:
the at least one electric vehicle comprises a plurality of electric vehicles; and
the variation calculator is configured to:
calculate the predicted energy parameter for each of the plurality of travel routes based on one of:
(i) the values of the traveling energy required for the traveling of each of the plurality of electric vehicle along the corresponding one of the plurality of travel routes; and
(ii) the values of the at least one influence factor for the corresponding one of the plurality of travel routes; and
calculate the actual measurement energy parameter for each of the plurality of travel routes based on one of:
(i) actually measured values of the traveling energy required for the traveling of each of the plurality of electric vehicles along the corresponding one of the plurality of travel routes; and
(ii) actually measured values of the at least one influence factor for the corresponding one of the plurality of travel routes.

10. A charging apparatus comprising:
a charging plan creating apparatus according to claim 1; and
a charging executing unit configured to:
execute charging of a battery of the first electric vehicle in accordance with the first charging plan for the first electric vehicle; and
execute charging of a battery of the second electric vehicle in accordance with the second charging plan for the second electric vehicle.

11. A charging program product for at least one processor, the program product comprising:
a non-transitory computer-readable storage medium; and
a set of computer program instructions stored in the computer-readable storage medium, the instructions causing the at least one processor to:
calculate, based on information on traveling energy required for a traveling of at least one electric vehicle along each of a plurality of travel routes, a level of energy variation in one of:
(i) values of the traveling energy required for the traveling of the at least one electric vehicle along each of the plurality of travel routes; and
(ii) values of at least one influence factor for each of the plurality of travel routes, the at least one influence factor influencing the traveling energy;
obtain the level of energy variation for a first travel route included in the plurality of travel routes as a first level of energy variation;
obtain the level of energy variation for a second travel route included in the plurality of travel routes as a second level of energy variation; and
allocate, based on a common stop time of both the first and second electric vehicles included in first and second traveling plans for the respective first and second electric vehicles, a usable charging time to the first and second electric vehicles in accordance a comparison between the first level of energy variation for the first travel route and the second level of energy variation for the second travel route to accordingly create first and second charging plans for the respective first and second electric vehicles.
